(19) United States
(12) Patent Application Publication
(10) Pub. No.: US 2012/0032775 A1
(43) Pub. Date: Feb. 9, 2012

(54) ENTRY/EXIT CONTROLLING SYSTEM AND METHOD

(75) Inventor: Makoto Kikuchi, Tokyo (JP)

(73) Assignee: YAMATAKE CORPORATION, Tokyo (JP)

(21) Appl. No.: 13/197,034

(22) Filed: Aug. 3, 2011

(30) Foreign Application Priority Data
Aug. 5, 2010 (JP) 2010-176029

(51) Int. Cl. G05B 19/00

(52) U.S. Cl. 340/5.2

(57) ABSTRACT

Reader terminals are provided on both sides of doors accessing different areas and are provided on at least one side of doors accessing regions of the same area. An evaluation processing portion evaluates if there is an anti-pass-back violation by a user in response to an evaluation request from a reader terminal. A comparison an area ID for the movement origin region, obtained from the region information storing portion, and a current area ID for the user, obtained from the current location information storing portion is performed. If the result of the evaluations for entry/exit permission is that entry/exit is permitted and there is no anti-pass-back violation, then the area ID and the individual ID of the movement destination region, obtained from the region information storing portion, are stored as the current area ID and the current region ID for the user, in the current location information storing portion.

### CROSS REFERENCE TO RELATED APPLICATIONS

The present application claims priority under 35 U.S.C. §119 to Japanese Patent Application No. 2010-176029, filed Aug. 5, 2010, which is incorporated herein by reference.

### FIELD OF TECHNOLOGY

The present invention relates to an entry/exit controlling technology, and, in particular, relates to an entry/exit controlling technology wherein, when evaluating the entry/exit of a user, an anti-pass-back evaluation is performed in order to detect an illegal entry/exit by the user.

### BACKGROUND OF THE INVENTION

In an entry/exit controlling system for controlling entry/exit of users using a plurality of regions provided in a facility, recording media, such as ID cards, recorded with individual identification numbers for identification of individuals, are distributed in advance to users, and when a user enters any given region, an evaluation is made as to whether or not the entry/exit by the user is authorized, based on the individual identification number, which is read from the ID card by a reader terminal, such as a card reader, placed at the entrance/exit of the region, when a user is entering or exiting any given region, where an electric lock that is provided on a door of the region is unlocked depending on the evaluation that entry/exit is prevented.

Additionally, in this entry/exit controlling system, in some cases and anti-pass-back evaluation, where the movement of the user is checked, is performed in order to detect the illegal entry/exit of a user through illegal use or misuse of an ID card. In this case, first, a region ID of a movement origin region and a movement destination region wherein there is passage through the corresponding gate is recorded at each reader terminal and, depending on the evaluation of the entry location, a region ID that indicates the current location of the user is stored as the current region ID, in order to perform occupancy control by region. Then, at the time of an entrance evaluation, the movement origin IL) and the user current region ID are compared, in order to perform the anti-pass-back evaluation (See, for example, Japanese Unexamined Patent Application Publication 2010-020517).

In this type of entry/exit controlling system, depending on the region, only the entry is checked, and there are many regions from which one may exit freely, without being checked at exiting. Consequently, in this type of region, one may consider reducing the number of reader terminals for exiting, making it possible to reduce the costs of the system as a whole.

However, in this type of conventional technology, individual region IDs for the individual regions, set in advance for each of the regions, are used for the movement origin region ID and the movement destination region ID used in the anti-pass-back evaluation, and thus it is necessary to ascertain accurately the current region ID of the user by checking strictly the entering and exiting of each region. Consequently, if the number of reader terminals for exits of regions from which one may exit freely is reduced, then there is a problem in that it becomes impossible to perform anti-pass-back evaluations accurately.

That is, if the number of exit reader terminals of a free-exit region X were reduced, then even after exiting from the region X to a region Y, still the current region ID for the user would show the region X from before the movement. Because of this, if the user then moves from the region Y to a region Z, the current region ID of the user would still indicate the region X, notwithstanding occupancy in the region Z, so, at this time, the result would be an evaluation that there is a pass-back violation. Consequently, if the anti-pass-back evaluations are to be performed accurately, it is not possible to reduce the number of reader terminals for exiting the region X.

The present invention is to solve this type of problem, and the object thereof is to provide an entry/exit controlling technology wherein anti-pass-back evaluations can be performed accurately, even if the number of exit reader terminals of a free-exit region is reduced.

### SUMMARY OF THE INVENTION

In order to achieve the object set forth above, the entry/exit controlling system according to the present invention, for evaluating entry/exit authorization of a user regarding individual regions provided in a facility and for performing anti-pass-back evaluations for that user, includes a region information storing portion for storing an individual ID, for identifying the region, for each individual region, along with an area ID for identifying the area for each individual area for which the anti-pass-back evaluation is performed, structured from one or more regions; a user information storing portion for storing, for each user, evaluation information for evaluating entry/exit authorization for the region; a current location information storing portion for storing, for each user, the current individual ID that indicates the individual ID of the region wherein the user is present, and the current area ID that indicates the area ID of the area wherein the user is present; reader terminals, provided at both sides of at least those doors for moving into regions that are in different areas, of those doors provided at regions, with the reader terminals provided at one of the sides of doors for moving into regions within the same area, of those doors provided at regions, so as to send evaluation requests for requesting user entry/exit request evaluations regarding the movement destination region from the movement origin region, in response to a user operation; and an evaluation processing portion for not only evaluating entry/exit authorization of a user for a movement destination region based on evaluation information for the user obtained from the user information storing portion in response to an evaluation request from a reader terminal, but also for performing an anti-pass-back evaluation for a user through comparing a movement origin region area ID, obtained from the region information storing portion, and a current area ID for the user, obtained from the current location information storing portion, and, if there is a result of the entry/exit authorization evaluation indicating entry/exit authorization and an evaluation that there is no anti-pass-back violation, for issuing an instruction to unlock an electric lock that is provided at the region, and for storing the current area ID of the user, from the current location information storing portion, as the current region ID, and for storing the individual ID and the area ID of the movement destination region, obtained from the region information storing portion.

In this case, for each region, an individual ID and an area ID may be stored as region codes that include the individual ID and the area ID in the region information storing portion; the current individual ID and the current area ID may be stored in the current location information storing portion as a current region code that includes the current individual ID and the current area ID; and at the time of an anti-pass-back evaluation in the evaluation processing portion, an area ID may be extracted from the region code of the movement origin region obtained from the region information storing portion and a current area ID may be extracted from the current region code of the user, obtained from the current location information storing portion, and if the result of the entry/exit authorization validation indicates entry/exit authorization and there is an evaluation that there is no anti-pass-back violation, an instruction may be given to unlock the electric lock that is provided at the region, and the region code of the movement destination region, obtained from the region information storing portion may be stored as the current region code for the user in the current location information storing portion.

Additionally, the entry/exit controlling of exit method according to the present invention, for use in and entry/exit controlling system for evaluating entry/exit authorization of a user regarding individual regions provided in a facility and for performing anti-pass-back evaluations for that user, has a region information storing step wherein a region information storing portion stores an individual ID, for identifying the region, for each individual region, along with an area ID for identifying the area for each individual area for which the anti-pass-back evaluation is performed, structured from one or more regions; a user information storing step wherein a user information storing portion stores, for each user, evaluation information for evaluating entry/exit authorization for the region; a current position information storing step wherein a current location information storing portion stores, for each user, the current individual ID that indicates the individual ID of the region wherein the user is present, and the current area ID that indicates the area. ID of the area wherein the user is present; an evaluation requesting step wherein a reader terminal, of those provided at both sides of at least those doors for moving into regions that are in different areas, of those doors provided at regions, with the reader terminals provided at one of the sides of doors for moving into regions within the same area, of those doors provided at regions, sends an evaluation request for requesting a user entry/exit request evaluation regarding the movement destination region from the movement origin region, in response to a user operation; and an evaluation processing step wherein an evaluation processing portion not only evaluates entry/exit authorization of a user for a movement destination region based on evaluation information for the user obtained from the user information storing portion in response to an evaluation request from a reader terminal, but also performs an anti-pass-back evaluation for a user through comparing a movement origin region area ID, obtained from the region information storing portion, and a current area ID for the user, obtained from the current location information storing portion, and, if there is a result of the entry/exit authorization evaluation indicating entry/exit authorization and an evaluation that there is no anti-pass-back violation, issues an instruction to unlock an electric lock that is provided at the region, and stores the current area ID of the user, from the current location information storing portion, as the current region ID, and stores the individual ID and the area ID of the movement destination region, obtained from the region information storing portion.

In this case, for each region, an individual ID and an area ID may be stored as region codes that include the individual ID and the area ID in the region information storing step; the current individual ID and the current area ID may be stored in the current location information storing step as a current region code that includes the current individual ID and the current area ID; and at the time of an anti-pass-back evaluation in the evaluation processing portion, an area ID may be extracted from the region code of the movement origin region obtained from the region information storing portion and a current area ID may be extracted from the current region code of the user, obtained from the current location information storing portion, and if the result of the entry/exit authorization validation indicates entry/exit authorization and there is an evaluation that there is no anti-pass-back violation, an instruction may be given to unlock the electric lock that is provided at the region, and the region code of the movement destination region, obtained from the region information storing portion may be stored as the current region code for the user in the current location information storing step.

Given the present invention, when a user moves to a region of a different area after moving between regions within the same area, the anti-pass-back evaluation can be performed with accuracy because the current area ID of the user has not changed when the user moved within the same area. Because of this, even when there is free movement between regions within the same area, without performing entry/exit evaluations, it is still possible to perform anti-pass-back evaluations for movements between areas.

### BRIEF DESCRIPTION OF THE DRAWINGS

FIG. 1 is a block diagram illustrating a structure of an entry/exit controlling system according to an example.

FIG. 2 is a structural example of region information according to the example.

FIG. 3 is a structural example of terminal information.

FIG. 4 is a structural example of user information,

FIG. 5 is a structural example of present position information according to the example.

FIG. 6 is a flowchart illustrating the entry/exit evaluation operation of the entry/exit controlling system according to the example.

FIG. 7 is an explanatory diagram illustrating an example of the entry/exit evaluation operation of the entry/exit controlling system according to the example.

FIG. 8 is a structural example of a region code.

FIG. 9 is a structural example of region information according to another example.

FIG. 10 is a structural example of present position information according to the other example.

FIG. 11 is an explanatory diagram illustrating an example of the entry/exit evaluation operation of the entry/exit controlling system according to the other example.

### DETAILED DESCRIPTION OF THE PRESENT INVENTION

Forms for carrying out the present invention will be explained next in reference to the figures.

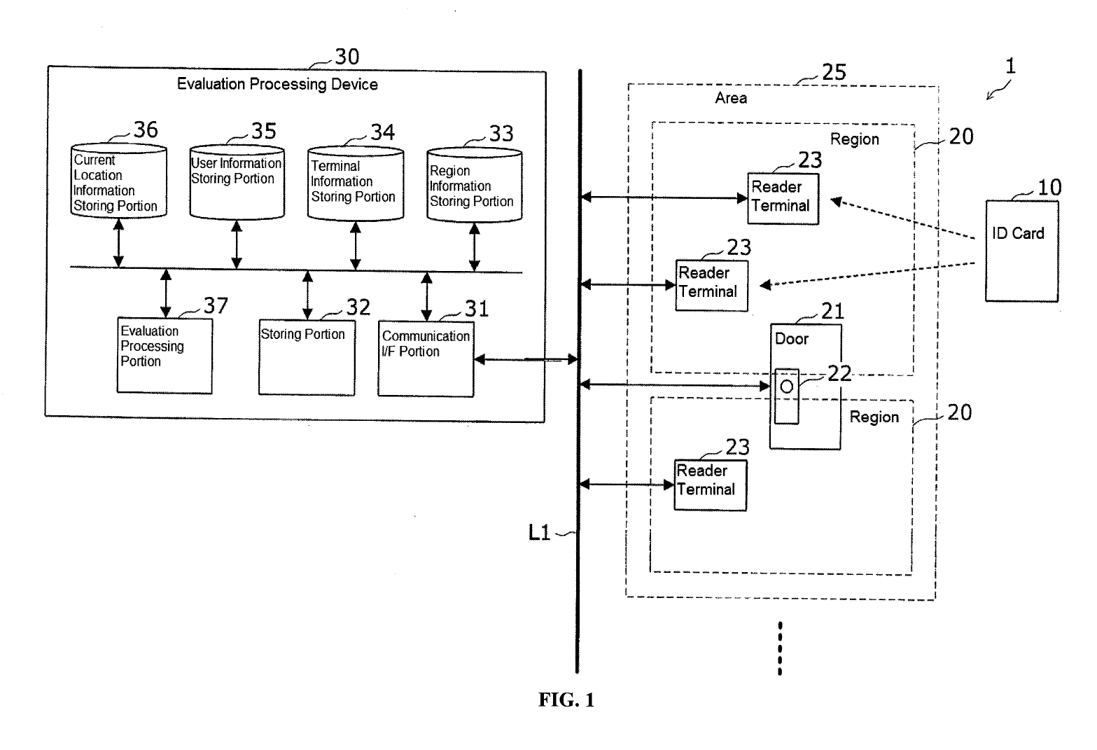

An entry/exit controlling system according to an example of the present invention is explained in reference to FIG. 1. FIG. 1 is a block diagram illustrating a structure of an entry/exit controlling system.

The entry/exit controlling system 1 includes: an ID card 10, an electric lock 22, a reader terminal 23, and an evaluation processing device 30. An electric lock 22 and a reader terminal 23 are disposed at each individual region 20, and are connected to the evaluation processing device 30, so as to each be able to perform data communications, through communications lines L1. These electric locks 22 and reader terminals 23 are disposed in a plurality depending on the scope of the entry/exit controlling system 1.

The ID card 10 has a mobile card for data processing, such as a memory card or an IC card, and has a function for recording user identification information, such as a user ID that is permanent for the user, as information required for evaluating whether or not the user who has the ID card is allowed to pass.

A region 20 is a unit for which user entry/exit is controlled, where an area 25 is a unit for evaluating whether or not there is an anti-pass-back violation, structured from one or more regions 20. The electric lock 22 has a function for performing unlocking/locking of a door 21 in accordance with an instruction for unlocking/locking from the evaluation processing device 30, received through the communication line L1, and has an electrically actuated lock, and is provided for each door 21 of a region 20. Note that the electric lock 22 is usually locked, and is unlocked for only a specific period of time when an unlock instruction arrives from the evaluation processing device 30.

The reader terminal 23 includes a card processing device such as a card reader, having a function for reading card information from the ID card 10 presented by the user, through inserting the ID card into a card slot (contact type) or through holding the ID card up to a card antenna (non-contact type), and a function for sending and receiving the card information through the communication line L1 to the evaluation processing device 30.

Of the doors 21 that are provided in each of the regions 20, those doors 21 for moving into regions 20 that belong to different areas 25 are each provided with reader terminals 23 on both sides (the entry side and the exit side) of the door 21. Moreover, for a door 21 for moving to a region within the same area 25, a reader terminal 23 is located on one side of the door 21 (the entry side or the exit side). Consequently, for doors 21 that are provided between regions 20 belonging to the same area 25, if no evaluation as to whether or not there is entry/exit authorization for either of the directions of movement is to be made, then the reader terminal 23 that is operated at the time of this movement may be eliminated.

The evaluation processing device 30 is made from a controlling device, such as a controller that is used in various types of controlling systems that perform facilities control and monitoring, or from an information processing device such as a server machine or a PC, and has a function for performing entry/exit authorization evaluations for users of the various regions 20, and for performing anti-pass-back evaluations for inspecting for illegal entry/exit by the users.

As the main functional portions, the evaluation processing device 30 is provided with a communication interface portion (hereafter termed the communication I/F portion) 31, the storing portion 32, the region information storing portion 33, the terminal information storing portion 34, the user information storing portion 35, the current location information storing portion 36, and the evaluation processing portion 37, where these functional portions are connected to each other through an internal bus so as to enable the exchange of data.

The communication I/F portion 31 has a function for performing data communication through a communication line L1 with the electric lock 22 and the reader terminal 23, and also with external devices such as an information processing device (not shown) such as a server device or a PC. The storing portion 32 comprises a storage device such as a memory or a hard disk, and has a function for storing the various types of data. and programs used in the processing operations by the evaluation processing device 30.

The region information storing portion 33 comprises a storage device such as a memory or a hard disk, and stores an individual ID for identifying the region 20, for each individual region 20 for which entry/exit is to be controlled, and the area ID for identifying the area 25 for each area 25 for which anti-pass-back evaluation is to be performed, structured from one or more regions 20. FIG. 2 is a structural example of region information according to the first form of embodiment. Here a combination of a region ID, a region name, an individual ID, and an area ID is stored for each region 20. In regards to the individual ID, although it need only enable the identification of the region 20 within the area 25, it may also be able to identify regions 20 across areas 25.

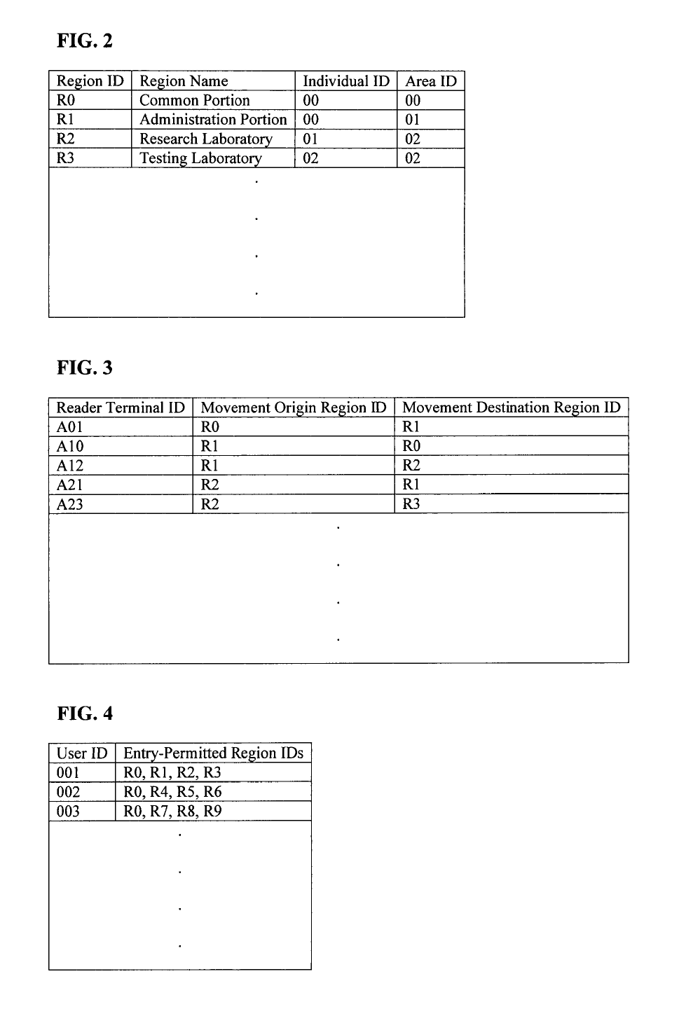

The terminal information storing portion 34 comprises a storage device such as a memory or a hard disk, and is a storing portion for storing, for each reader terminal 23, the movement origin region and the movement destination region for evaluating the entry/exit in the operation of the reader terminal 23. FIG. 3 is a structural example of terminal information. Here a combination of a movement origin region ID that indicates the region ID for the movement origin region, and a movement destination region ID that indicates the region ID for the movement destination region, are stored for each reader terminal 23.

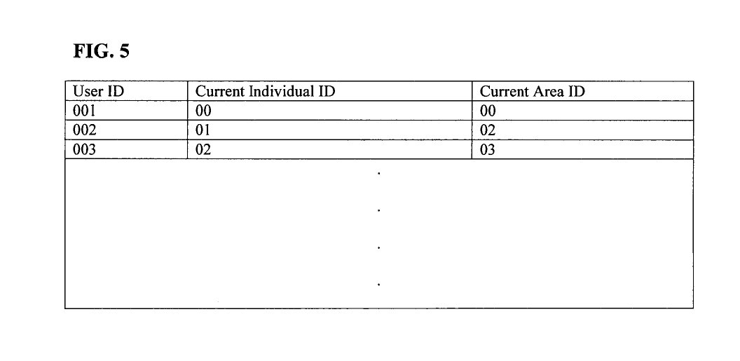

The user information storing portion 35 includes a storage device such as a memory or a hard disk, and is a storing portion for storing, for each individual user that uses the region 20, a combination of the user identification information such as a user ID for identifying the user, and evaluation information, such as an entry-permitted region ID for evaluating the entry/exit authorization for the user for each individual region. FIG. 4 is a structural example of user information. Here an entry-permitted region ID that presents a list of region IDs of the regions through which the user can pass is stored for each user.

The current location information storing portion 36 includes a storage device such as a memory or a hard disk, and is a storing portion for storing, for each user that uses the region 20, current location information, such as a current individual ID or a current area ID pertaining to the current location of the user. FIG. 5 is a structural example of present position information according to the example. Here, for each user ID, a combination of a current area ID, indicating the area ID of the area wherein the user is present, and a current region ID, indicating the region ID of the region wherein the user is present, are stored.

The evaluation processing portion 37 is structured from a calculation processing portion wherein a CPU and a program operate cooperatively, and has a function for evaluating whether or not a user has entry/exit authorization for a movement destination region ID, based on the result of a comparison of a movement destination region ID, obtained from the terminal information storing portion 34 based on the reader terminal ID that was specified in an evaluation request, in response to the evaluation request from the reader terminal 23, received through the communication I/F portion 31, and the entry-permitted region IDs for the user, obtained from the user information storing portion 35, based on the user ID specified in the evaluation request.

Additionally, the evaluation processing portion 37 has a function for obtaining the movement destination region ID from the terminal information storing portion 34 based on the reader terminal ID specified in the evaluation request and comparing the area ID, obtained from the region information storing portion 33 based on the movement destination region ID, to the current area ID of the user, obtained from the current location information storing portion 36 based on the user ID specified in the evaluation request, to evaluate whether or not there has been a pass-back violation for the user, and also function wherein, if the result of the entry/exit authorization evaluation is that entry/exit is authorized and also the evaluation was that there is no anti-pass-back violation, not only is there an unlock instruction from the communication I/F portion 31 to the electric lock 22 corresponding to the reader terminal 23, but also the area. ID and the individual ID of the movement destination region, obtained from the region information storing portion 33, are stored as the current area ID and the current region ID for the user in the current location information storing portion 36.

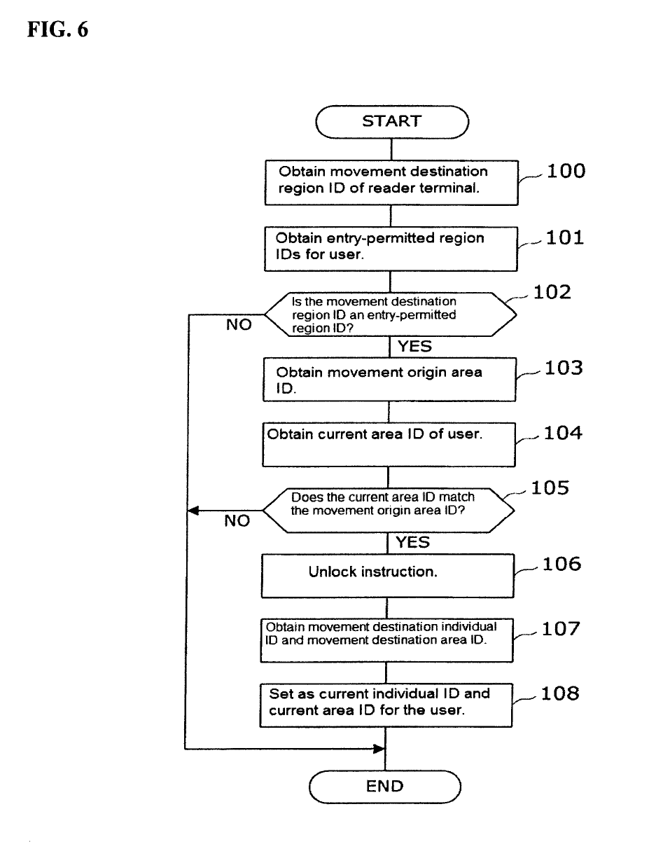

FIG. 6 will be referenced next in order to explain the entry/exit evaluation operation for the entry/exit controlling system according to an example. FIG. 6 is a flowchart illustrating the entry/exit evaluation operation of the entry/exit controlling system according to the example. The evaluation processing portion 37 of the evaluation processing device 30 performs the entry/exit evaluation processes of FIG. 6 in response to an evaluation request from a reader terminal 23, received by the communication I/F portion 31.

First the evaluation processing portion 37 obtains the movement destination region ID from the terminal information storing portion 34 based on the reader terminal ID specified in the evaluation request (Step 100), and obtains the entry-permitted region IDs for the user from the user information storing portion 35 based on the user ID specified in the evaluation request (Step 101). Following this, the evaluation processing portion 37 checks whether or not the movement destination region ID is included in the entry-permitted region IDs (Step 102), and if the movement destination region ID is not included in the entry-permitted region IDs (Step 102: NO), then the evaluation processing portion 37 evaluates that entry of the user into the movement destination region is not permitted, and the series of entry/exit evaluating processes is terminated. Doing so causes the electric lock 22 of the corresponding door 21 to remain locked, so that the user is unable to enter into the movement destination region.

On the other hand, if the movement destination region ID is included in the entry-permitted region IDs (Step 102: YES), then after the evaluation processing portion 37 has obtained the movement origin region ID from the terminal information storing portion 34 based on the reader terminal ID specified in the evaluation request, it obtains the movement origin area ID, which indicates the area ID of the movement origin region, from the region information storing portion 33 based on the movement origin region ID (Step 103), and obtains the current area ID for the user from the current location information storing portion 36 based on the user ID specified in the evaluation request (Step 104).

Following this, the evaluation processing portion 37 then checks for a match between the movement origin area ID and the current area ID (Step 105), and if the movement origin area ID and the current area ID do not match (Step 105: NO), the evaluation processing portion 37 concludes that there has been an anti-pass-back violation with the user in the movement origin area, and terminates the series of entry/exit evaluation processes. Doing so causes the electric lock 22 of the corresponding door 21 to remain locked, so that the user is unable to enter into the movement destination region.

On the other hand, if the movement origin area ID matches the current area (Step 105: YES), then the evaluation processing portion 37 determines that there has been no anti-pass-back violation by the user in the movement origin area, and sends, from the communication I/F portion 31, an unlock instruction to the electric lock 22 corresponding to the reader terminal 23 (Step 106).

Following this, after obtaining the movement destination region ID from the terminal information storing portion 34 based on the reader terminal ID specified in the evaluation request, the evaluation processing portion 37 obtains the movement destination individual ID that indicates the individual ID of the movement destination region, and the movement destination area ID, which indicates the area ID of the movement destination region, from the region information storing portion 33 based on the movement destination region ID (Step 107), and stores these movement destination individual ID and movement destination area ID in the current location information storing portion 36 as the current individual ID and the current area ID of the user (Step 108), to complete the series of entry/exit evaluation processes.

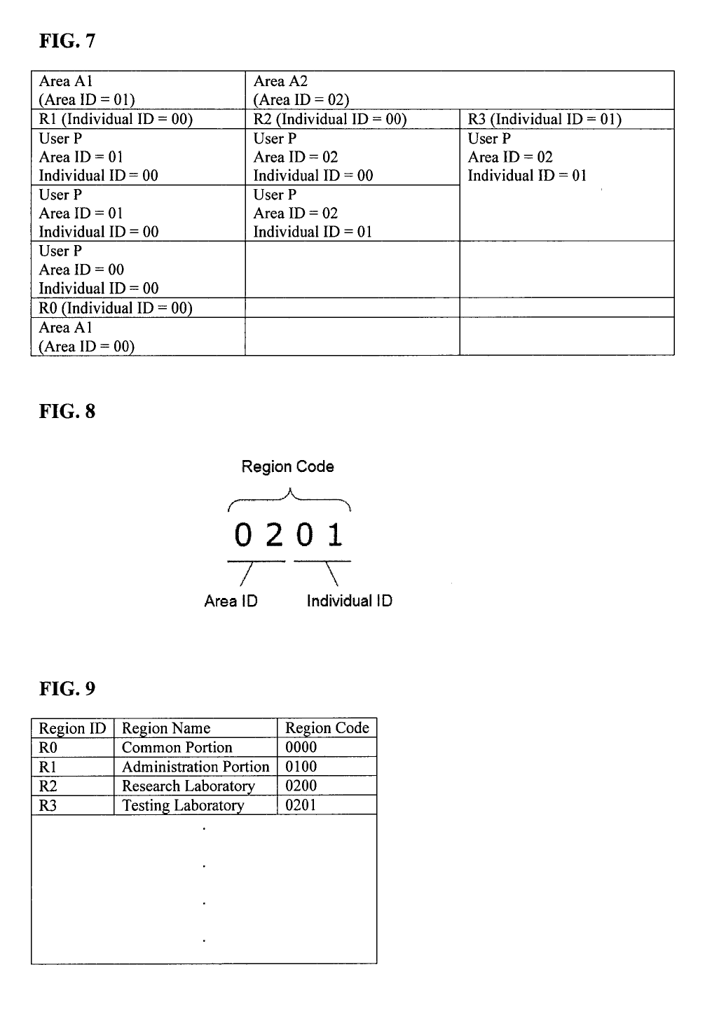

An example of the entry/exit evaluation operations of the entry/exit controlling system according to an example is explained in reference to FIG. 7. FIG. 7 is an explanatory diagram illustrating an example of the entry/exit evaluation operation of the entry/exit controlling system.

In the example in FIG. 7, four regions R0 through R3 are set up, and, as illustrated in FIG. 2, described above, region R0 is a common portion, region R1 is an administration portion, region R2 is a research laboratory, and region R3 is a testing laboratory. These regions R0 through R3 are connected through doors in a grid, where movement from region R0 to region R3 would be from region R0 through regions R1 and R2, to region R3.

Additionally, regions R0 through R3 are provided with three areas A0 through the A2, as units for anti-pass-back evaluation. Of these, the area A0 is made up of the region R0, the area of the A1 is made up of up of the region R1, and the area A2 is up of from the regions R2 and R3. At this time, the area IDs 00, 01, and 02 are assigned, respectively, to the areas A1, A2, and A3, and the individual IDs 00, 00, 00, and 01 are assigned, respectively, to the regions R0, R1, R2, and R3.

Additionally, a reader terminal T01 is provided on the region R0 side of the door for passing back and forth between the region R0 and the region R1, and a reader terminal T10 is provided on the region R1 side. Moreover, at the door for passing back and forth between the region R1 and the region R2, a reader terminal T12 is provided on the region R1 side, and a reader terminal T21 is provided on the region R2 side. Additionally, while a reader terminal T23 is provided on the region R2 side of the door for passing back and forth between the region R2 and the region R3, no reader terminal is provided on the region R3 side. This is because the regions R2 and R3 belong to the same area A2, and the region R3 is a free-exit region wherein there is no need to perform an exit evaluation.

The changes in the anti-pass-back evaluation and the current location information when the user, presently in region R0, moves through regions R1 and R2 to the region R3. Note that the user P is authorized to pass through these regions R0 through R3, and explanations regarding the entry/exit authorization evaluation are omitted.

First the user P operates the reader terminal T01 in order to pass from region R0 to region R1. In this case, the area ID of the movement origin region R0 is 00, and the current area ID of the user P is also 00, and thus the evaluation is that there is no anti-pass-back violation for the user P in region R0, and so entry into the region R1 is permitted. Doing so causes the current area ID for the user P to become 01, and the individual ID to be 00.

Next the user P operates the reader terminal T12 in order to pass from region R1 to region R2. In this case, the area ID of the movement origin region R1 is 01, and the current area ID of the user P is also 01, and thus the evaluation is that there is no anti-pass-back violation for the user P in region R1, and so entry into the region R2 is permitted. Doing so causes the current area ID for the user P to become 02, and the individual ID to be 00.

Next the user P operates the reader terminal T23 in order to pass from region R2 to region R3. In this case, the area ID of the movement origin region R2 is 02, and the current area ID of the user P is also 02, and thus the evaluation is that there is no anti-pass-back violation for the user P in region R2, and so entry into the region R3 is permitted. Doing so causes the current area ID for the user P to remain 02, and the individual ID to become 01.

The changes in the anti-pass-back evaluation and the current location information when the user, presently in region R3, moves through regions R2 and R1 to the region R0. Note that the user P is authorized to pass through these regions R0 through R3, and explanations regarding the entry/exit authorization evaluation are omitted.

First, when the user P moves from the region R3 to the region R2, the region R3 is a free-exit region, and thus the user P can exit freely into the region R2. Doing so causes the current area ID for the user P to be 02, and the individual ID to remain 01.

Next, the user P operates the reader terminal T21 in order to pass from region R2 to region R1. In this case, the area ID of the movement origin region R2 is 02, and the current area ID of the user P is also 02, and thus the evaluation is that there is no anti-pass-back violation for the user P in region R2, and so entry into the region R1 is permitted. Doing so causes the current area ID for the user P to become 01, and the individual ID also to be 00.

At this time, because the reader terminal for exiting the region R3, half which is a free-exit region, has been eliminated, the anti-pass-back evaluation is performed using the area ID of the area A2, which is the same for both regions R2 and R3, and thus when moving into the region R2, while maintaining the same current location information from the region R3, still the evaluation in the region R2 is that there is no anti-pass-back violation.

Additionally when it comes to the current location of the user in the area A2, the current identification ID of the user changes together with the movement from the region R2 to the region R3, thus making it possible to understand in detail the current location of the user even within the area A2; however, when there is a movement from the region R3 to the region R2, there is no change in the current individual ID, and thus the current location of the user will be within either the region R3 or the region R2, or in other words, within the area A2.

Next the user P operates the reader terminal T10 in order to pass from region R1 to region R0. In this case, the area ID of the movement origin region R1 is 01, and the current area ID of the user P is also 01, and thus the evaluation is that there is no anti-pass-back violation for the user P in region R1, and so entry into the region R0 is permitted. Doing so causes the current area ID for the user P to become 00, and the individual ID to become 00.

In this way, in the present example, of the doors that are provided in the various regions 20, reader terminals 23 are provided on both sides of doors for movement into regions 20 of different areas and are provided on at least one side of doors for moving into regions 20 of the same area, where, in the evaluation processing portion, and anti-pass-back evaluation is performed for the user in response to an evaluation request from a reader terminal 23, by comparing an area ID for the movement origin region, obtained from the region information storing portion 33, and a current area ID for the user, obtained from the current location information storing portion 36, where if the result of the entry/exit permission evaluation is that entry/exit is permitted and the evaluation is that there is no anti-pass-back violation, then the area ID and the individual ID of the movement destination region, obtained from the region information storing portion 33, are stored as the current area ID and the current region ID for the user, in the current location information storing portion 36.

Given this, when a user moves to a region 20 of a different area 25 after moving between regions 20 within the same area, the anti-pass-hack evaluation can be performed with accuracy because the current area ID of the user has not changed when the user moved within the same area. Because of this, even when there is free movement between regions 20 within the same area 25, without performing entry/exit evaluations, it is still possible to perform anti-pass-back evaluations for movements between areas 25.

Additionally, given the present example, the entry/exit evaluation is performed by the reader terminal 23 that is located on one of the sides of the door for movement into a region within the same area, of the doors that are provided at the regions, and thus even if the user moves between regions belonging to the same area, it is still possible to obtain some degree of security, and possible to understand the current location of the user.

Additionally, in the present example, the individual ID is not used for the anti-pass-back evaluation, thus making it possible to assign individual IDs to each of the regions 20, independent of the anti-pass-back evaluations. Because of this, even when it is necessary to change the structure of the regions 20, it is possible to change the structure of the regions freely, without having to consider changes in the anti-pass-back evaluations, as long as it is possible to handle as changes within the same areas 25, enabling easy handling of changes in the scope of modifications to the organization.

An entry/exit controlling system according to another example of the present invention is explained next.

A case wherein area IDs and individual IDs were assigned individually to each region 20 and each user to perform anti-pass-back evaluations and current location control was explained in the first form of embodiment. In the present example the explanation is for a case wherein these area IDs and individual IDs are handled as single region codes.

FIG. 8 is a structural example of a region code. The region code is a code for identifying each region 20, where an individual value is assigned to each region 20. In the example in FIG. 8, the region code is structured from a four-digit number, of which the first two digits are assigned to the area used in the previous example, and the last two digits are assigned to the individual ID used in the previous example. Note that FIG. 8 is no more than a structural diagram, and there is no limitation thereto, but rather the area. IDs and individual IDs may be included in any of the digits in the region codes.

FIG. 9 is a structural example of region information according to the example. Here, when compared to FIG. 2, described above, the individual ID and the region ID are stored as a single region code.

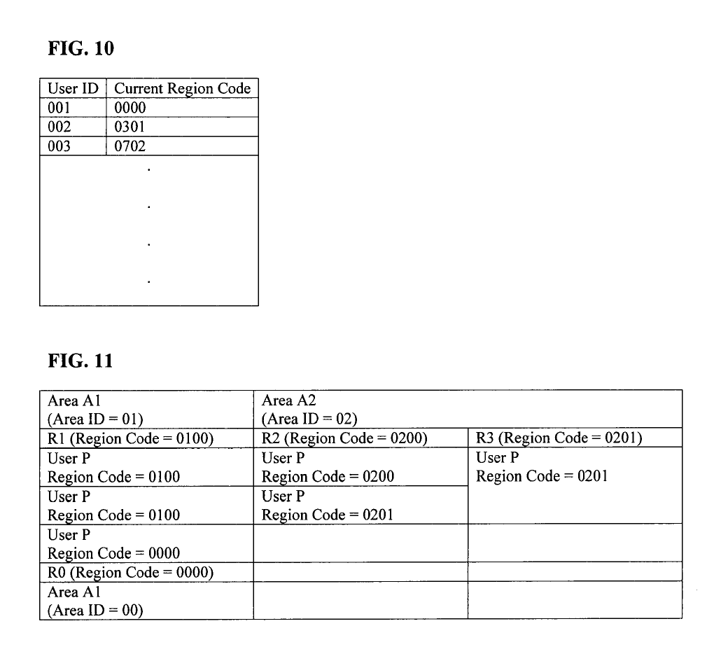

FIG. 10 is a structural example of present position information according to this example, in this case, when compared to FIG. 5, described above, the current individual ID and the current region ID are stored as a single current region code.

The other structures and operations of the entry/exit controlling system according to this example are identical to those in the above example, and thus detailed explanations thereof are omitted.

An example of the entry/exit evaluation operations of the entry/exit controlling system according to this example is explained next in reference to FIG. 11. FIG. 11 is an explanatory diagram illustrating an example of the entry/exit evaluation operation of the entry/exit controlling system according to another example.

In the example in FIG. 11, as was the case for FIG. 7, described above, four regions R0 through R3 are set up, and, as illustrated in FIG. 2, described above, region R0 is a common portion, region R1 is an administration portion, region R2 is a research laboratory, and region R3 is a testing laboratory. These regions R0 through R3 are connected through doors in a grid, where movement from region R0 to region R3 would be from region R0 through regions R1 and R2, to region R3.

Additionally, regions R0 through R3 are provided with three areas A0 through the A2, as units for anti-pass-back evaluation. Of these, the area A0 is made up of the region R0, the area of the A1 is made up of up of the region R1, and the area A2 is up of from the regions R2 and R3.

At this time, the area IDs 00, 01, and 02 are assigned, respectively, to the areas A1, A2, and A3, and the individual IDs 00, 00, 00, and 01 are assigned, respectively, to the regions R0, R1, R2, and R3. Consequently, given the region code structure of FIG. 8, the region codes for the regions R00, R1, R2, and R3, respectively, 0000, 0100, 0200, and 0201.

Additionally, a reader terminal T01 is provided on the region R0 side of the door for passing back and forth between the region R0 and the region R1, and a reader terminal T10 is provided on the region R1 side. Moreover, at the door for passing back and forth between the region R1 and the region R2, a reader terminal T12 is provided on the region R1 side, and a reader terminal T21 is provided on the region R2 side. Additionally, while a reader terminal T23 is provided on the region R2 side of the door for passing back and forth between the region R2 and the region R3, no reader terminal is provided on the region R3 side. This is because the regions R2 and R3 belong to the same area A2, and the region R3 is a free-exit region wherein there is no need to perform an exit evaluation.

The changes in the anti-pass-back evaluation and the current location information when the user, presently in region R0, moves through regions R1 and R2 to the region R3. Note that the user P is authorized to pass through these regions R0 through R3, and explanations regarding the entry/exit authorization evaluation are omitted.

First the user P operates the reader terminal T01 in order to pass from region R0 to region R1. In this case, the region code of the movement origin region R0 is 0000, and the area ID is 00, and the current region code of the user P is 0000, so the current area ID is also 00, and thus the evaluation is that there is no anti-pass-back violation for the user P in region R0, and so entry into the region R1 is permitted. Given this, the current region code for the user P becomes 0100.

Next the user operates the reader terminal T12 in order to pass from region R1 to region R2. In this case, the region code of the movement origin region R1 is 0100, and the area ID is 01, and the region code of the user P is 0100, so the current area is also 01, and thus the evaluation is that there is no anti-pass-back violation for the user P region R1, and so entry into the region R2 is permitted. Given this, the current region code for the user P becomes 0200.

Next the user P operates the reader terminal T23 in order to pass from region R2 to region R3. In this case, the region code of the movement origin region R2 is 0200, and the area ID is 02, and the region code of the user P is 0200, so the current area ID is also 02, and thus the evaluation is that there is no anti-pass-back violation for the user P region R2, and so entry into the region R3 is permitted. Given this, the current region code for the user P becomes 0201.

The changes in the anti-pass-back evaluation and the current location information when the user, presently in region R3, moves through regions R2 and R1 to the region R0. Note that the user P is authorized to pass through these regions R0 through R3, and explanations regarding the entry/exit authorization evaluation are omitted.

First, when the user P moves from the region R3 to the region R2, the region R3 is a free-exit region, and thus the user P can exit freely into the region R2. Given this, the current region code for the user P remains 0201.

Next the user P operates the reader terminal T21 in order to pass from region R2 to region R1. In this case, the region code of the movement origin region R2 is 0200, and the area ID is 02, and the current region code of the user P is 0201, so the area ID is also 02, and thus the evaluation is that there is no anti-pass-back violation for the user P in region R2, and so entry into the region R1 is permitted. Given this, the current region code for the user P becomes 0100.

At this time, because the reader terminal for exiting the region R3, with which is a free-exit region, has been eliminated, the anti-pass-back evaluation is performed using the area ID of the area A2, which is the same for both regions R2 and R3, and thus when moving into the region R2, while maintaining the same current location information from the region R3, still the evaluation in the region R2 is that there is no anti-pass-back violation.

Additionally when it comes to the current location of the user in the area A2, the current identification ID of the user changes together with the movement from the region R2 to the region R3, thus making it possible to understand in detail the current location of the user even within the area A2; however, when there is a movement from the region R3 to the region R2, there is no change in the current individual ID, and thus the current location of the user will be within either the region R3 or the region R2, or in other words, within the area A2.

Next the user P operates the reader terminal T10 in order to pass from region R1 to region R0. In this case, the region code of the movement origin region R1 is 0100, and the area ID is 01, and the current region code of the user P is 0100, so the area ID is also 01, and thus the evaluation is that there is no anti-pass-back violation for the user P in region R1, and so entry into the region R0 is permitted. Given this, the current region code for the user P becomes 0000.

In this way, in the example, the individual ID and the area ID are handled as a single region code, making it possible to reduce the number of times that each storing portion is accessed in the anti-pass-back evaluation process, enabling a reduction in the processing overhead and enabling an increase in the speed of processing.

While the present invention was explained above in reference to examples, the present invention is not limited by the examples set forth above. The structures and details of the present invention may be modified in a variety of ways, as can be understood by those skilled in the art, within the scope of the present invention.

1. An entry/exit controlling system for evaluating entry/exit authorization of a user regarding individual regions provided in a facility and for performing anti-pass-back evaluations for that user, comprising:
a region information storing portion storing an individual ID, for identifying the region, for each individual region, along with an area ID for identifying the area for each individual area for which the anti-pass-back evaluation is performed, structured from one or more regions;
a user information storing portion storing, for each user, evaluation information for evaluating entry/exit authorization for the region;
a current location information storing portion storing, for each user, the current individual ID that indicates the individual ID of the region wherein the user is present, and the current area ID that indicates the area ID of the area wherein the user is present;
reader terminals, provided at both sides of at least those doors moving into regions that are in different areas, of those doors provided at regions, with the reader terminals provided at one of the sides of doors moving into regions within the same area, of those doors provided at regions, so as to send evaluation requests for requesting user entry/exit request evaluations regarding the movement destination region from the movement origin region, in response to a user operation; and
an evaluation processing portion evaluating entry/exit authorization of a user for a movement destination region based on evaluation information for the user obtained from the user information storing portion in response to an evaluation request from a reader terminal, and performing an anti-pass-back evaluation for a user through comparing a movement origin region area ID, obtained from the region information storing portion, and a current area ID for the user, obtained from the current location information storing portion, and, if there is a result of the entry/exit authorization evaluation indicating entry/exit authorization and an evaluation that there is no anti-pass-back violation, for issuing an instruction to unlock an electric lock that is provided at the region, and for storing the current area ID of the user, from the current location information storing portion, as the current region ID, and for storing the individual ID and the area ID of the movement destination region, obtained from the region information storing portion.

2. The entry/exit controlling system as set forth in claim 1, wherein:
the region information storing portion stores, for each region, an individual ID and an area ID as region codes that include the individual ID and the area ID;
the current location information storing portion stores the current individual ID and the current area ID are stored as a current region code that includes the current individual ID and the current area ID; and
the evaluation processing portion, at the time of an anti-pass-back evaluation, extracts an area ID from the region code of the movement origin region obtained from the region information storing portion and extracts a current area ID from the current region code of the user, obtained from the current location information storing portion, and if the result of the entry/exit authorization validation indicates entry/exit authorization and there is an evaluation that there is no anti-pass-back violation, instructs unlocking of the electric lock that is provided at the region, and stores the region code of the movement destination region, obtained from the region information storing portion as the current region code for the user.

3. An entry/exit controlling method used by an entry/exit controlling system for evaluating entry/exit authorization of a user regarding individual regions provided in a facility and for performing anti-pass-back evaluations for that user, comprising:
a region information storing step wherein a region information storing portion stores an individual ID, for identifying the region, for each individual region, along with an area ID for identifying the area for each individual area for which the anti-pass-back evaluation is performed, structured from one or more regions;
a user information storing step wherein a user information storing portion stores, for each user, evaluation information for evaluating entry/exit authorization for the region;
a current position information storing step wherein a current location information storing portion stores, for each user, the current individual ID that indicates the individual ID of the region wherein the user is present, and the current area ID that indicates the area ID of the area wherein the user is present;
an evaluation requesting step wherein a reader terminal, of those provided at both sides of at least those doors for moving into regions that are in different areas, of those doors provided at regions, with the reader terminals provided at one of the sides of doors for moving into regions within the same area, of those doors provided at regions, sends an evaluation request for requesting a user entry/exit request evaluation regarding the movement destination region from the movement origin region, in response to a user operation; and
an evaluation processing step wherein an evaluation processing portion evaluates entry/exit authorization of a user for a movement destination region based on evaluation information for the user obtained from the user information storing portion in response to an evaluation request from a reader terminal, and performs an anti-pass-back evaluation for a user through comparing a movement origin region area ID, obtained from the region information storing portion, and a current area ID for the user, obtained from the current location information storing portion, and, if there is a result of the entry/exit authorization evaluation indicating entry/exit authorization and an evaluation that there is no anti-pass-back violation, instructs the unlocking of an electric lock that is provided at the region, and stores the current area ID of the user, from the current location information storing portion, as the current region ID, and stores the individual ID and the area ID of the movement destination region, obtained from the region information storing portion.

4. The entry/exit controlling method as set forth in claim 3, wherein:
the region information storing step stores for each region, an individual ID and an area ID as region codes that include the individual ID and the area ID;
the current location information storing step stores the current individual ID and the current area. ID are stored as a current region code that includes the current individual ID and the current area ID; and
the evaluation processing step, at the time of an anti-pass-back evaluation, extracts an area ID from the region code of the movement origin region obtained from the region information storing portion and extracts a current area ID from the current region code of the user, obtained from the current location information storing portion, and if the result of the entry/exit authorization validation indicates entry/exit authorization and there is an evaluation that there is no anti-pass-back violation, instructs unlocking of the electric lock that is provided at the region, and stores the region code of the movement destination region, obtained from the region information storing portion as the current region code for the user.
